(19) United States
(12) Patent Application Publication
(10) Pub. No.: US 2003/0225651 A1
(43) Pub. Date: Dec. 4, 2003

(54) System and method for fulfillment value at risk scoring

(76) Inventor: Yu-To Chen, Pleasanton, CA (US)

Correspondence Address: MINTZ LEVIN COHN FERRIS GLOVSKY AND POPEO PC, 12010 SUNSET HILLS ROAD, SUITE 900, RESTON, VA, 20190, US

(21) Appl. No.: 10/151,306

(22) Filed: May 21, 2002

(51) Int. Cl. G06F 17/60; G06G 7/00; G06F 15/18

(52) U.S. Cl. 705/36; 706/1

(57) ABSTRACT

The invention includes a system and method for generating fulfillment value at risk scores and assessing the stability of the fulfillment value at risk scores for a portfolio of location and item pairs. The fulfillment value at risk score may be generated using fuzzy logic inference and exploratory data analysis and its stability is assessed using bootstrap algorithms. The invention may include a data acquisition component, a location value scoring component, item fulfillment scoring component and a value at risk scoring component and a stability assessment component

The data acquisition component may include capturing key customer ordering and order fulfillment performance indices, performing data summary and scrubbing, and transforming transaction-based indices into an appropriate format for subsequent score processing. The location value scoring component may include generating location value scores for all or selected locations in a portfolio at or over one or more time periods. The item fulfillment scoring component may include generating item fulfillment scores for all or selected items in an inventory at or over one or more time periods. The value at risk scoring component may include generating value at risk scores based on location value scores and item fulfillment scores at or over one or more time periods. The stability assessment component may be applied to all of the three scores (item fulfillment, location value and value at risk scores) and yield statistical confidence intervals for the scores.

### FIELD OF THE INVENTION

The invention relates to creating fulfillment value at risk scores using fuzzy logic inference.

### BACKGROUND OF THE INVENTION

Fulfillment value at risk is an indicator of the appropriate value (e.g., dollar value) of a given location or customer with respect to the shipment or delivery fulfillment success rate for a given item. In competitive business fulfillment environments, service or product providers, including manufacturers and wholesalers, strive to ensure the highest level of fulfillment to the most valuable customers.

In situations where a company has limited resources, the company often desires to fulfill the orders of their most valuable customers first and the rest later. For at least this reason, the ability to measure customer value is important to service or product providers. The ability to improve order fulfillment for highly valued customers depends in part on the ability to constantly monitor customer value.

Fulfillment performance is also an important factor in evaluating fulfillment value at risk. Service or product providers, including manufacturers and wholesalers, generally aspire to track how well they fulfill orders for goods and services for their customers. To achieve the highest level of customer satisfaction, service or product providers often try to achieve 100% on-time shipment delivery with the minimum possible order to invoice time. At the same time, service and product providers recognize that there is a higher price for near perfect delivery. Because time and resources are limited, perfect delivery performance is not always possible. There exists a need for service or product providers to be able to use a scoring system to better enable task prioritization based on customer or location value assessment. In addition, the ability to improve customer satisfaction depends in part on the ability to constantly monitor, and ideally improve, order fulfillment performance.

However, to monitor any sizable number of location-item pairs in a portfolio is not a trivial task. At any given time, service or product providers may have to analyze hundreds of thousands of historical transactions and attempt, for example, to compare the fulfillment performance of items ABC and XYZ, and differentiate the relative value of location DEF and IJK. Such analysis is akin to simultaneous summarization of an N×M multivariate time-series (N, M being the number of items in a inventory and the number of locations in a portfolio, respectively) and then somehow ranking their relative importance.

Another obstacle to efficient exploitation of existing fulfillment data is the difficulties in assessing the data's accuracy. For example, even if a service or product provider obtains fulfillment scores for each item in an inventory, they may not have an effective way to assess the stability of the scores. Thus, they lack a technique to obtain a confidence interval measurement to enable conclusions about the stability of their scores, given the stochastic nature of data collection and model building process.

These and other drawbacks exist with existing technology.

### SUMMARY OF THE INVENTION

An advantage of the invention is that it overcomes these and other drawbacks of the existing systems and methods.

As pointed out in FIG. 1, the top level of this invention has three components. They are Data acquisition, Fuzzy scoring and Bootstrap algorithms. The second component, Fuzzy scoring, can be further broken down to three scoring mechanisms. They are Location value scores, Item fulfillment scores & Value at risk scores.

According to one embodiment, the invention includes a system and method for generating fulfillment value at risk scores for a portfolio of location and item pairs. According to one embodiment, the score is generated using fuzzy logic inference and exploratory data analysis. More specifically, this embodiment includes a data acquisition component, a location value scoring component, an item fulfillment scoring component and a value at risk scoring component.

The data acquisition component may include capturing key customer ordering and order fulfillment performance indices, performing data summary and scrubbing, and transforming transaction-based indices into an appropriate format for subsequent score processing. The location value scoring component may include generating location value scores for all or selected locations in a portfolio at or over one or more time periods. The item fulfillment scoring component may include generating item fulfillment scores for all or selected items in an inventory at or over one or more time periods. The value at risk scoring component may include generating value at risk scores based on location value scores and item fulfillment scores at or over one or more time periods.

While the invention is not so limited, the data acquisition component may include capturing customer ordering characteristics and using these characteristics to determine location value scores; capturing product fulfillment characteristics and using these characteristics to determine item fulfillment scores; storing the location value scores and item fulfillment scores; applying value at risk inference rules to the location value scores and item fulfillment scores; and generating value at risk scores.

According to one embodiment, predetermined key performance indices (KPIs) (and other data) are captured, (e.g., from EDI documents in a supply chain communication network or otherwise) and are stored (e.g., in a relational database or otherwise). Each record in the database may represent a transaction per request date, per item, per location. The data from multiple records may be aggregated over predetermined periods of time (e.g., daily, weekly, monthly or other periods) by item and by location to create item fulfillment and location value scores. The location value scores and item fulfillment scores are input to a fuzzy logic inference engine to generate value at risk scores to provide a measure of risk assessment for each (or selected) location-item pairs. Thus, the system provides a micro view of individual location-item pair value at risk as well as a macro view of an overall fulfillment value at risk.

As used herein, a location may refer to a particular physical location (e.g., a warehouse at 123 Main Street), a particular customer or purchaser, a particular service location, some other identifier of a goods or service recipient, or other locations. Item refers to a particular product, goods or services, an inventory item or other items. In some instances in this application, locations and customers are used interchangeably as are items and products.

A goal of the invention is to derive fulfillment value at risk scores from a set of key performance indices for every pair of location and item in a service or product provider's portfolio. The set of key performance indices may include, but is not limited to, total dollar value of requests, average dollar value per quantity, percent of on time shipments, average shipment delay, average order to invoice time, and other KPIs. Additionally, the invention enables a user to develop a consistent and sustainable process for value at risk scoring applicable to other portfolio value at risk assessment.

Among other things, the invention provides for real-time monitoring of value at risk for a portfolio of locations and items. The invention also provides for a quantitative measure of value at risk based upon business know-how and mathematical inference. In addition, the invention enables service or product providers to prioritize day-to-day tasks and enable them to focus their attention and resources on fulfilling mission critical tasks.

Embodiments of the invention also comprise one or more modules to enable the generation of visual representations of value at risk scores as well as location value and item fulfillment scores. For example, the invention may enable the generation of histograms, or other visual representations that facilitate analysis of portfolio performance. Likewise, location value scores and item fulfillment scores may be presented in a visual format (e.g., histogram) to enable evaluation of location value or item fulfillment for a portfolio. Some embodiments of the invention also enable archiving of scores to facilitate historical evaluation (e.g., performance over time of portfolios. A series of such histograms can be constantly monitored over time to provide outstanding risk management information and insights for continuous business process improvement.

According to one embodiment, the value at risk scoring has two by-product scores. They are location value and item fulfillment scores. Location value scores enable the service or product providers a way to better server their best customers. Item fulfillment scores make it feasible to feedback the fulfillment performance to their distribution channels or manufacturing processes for ongoing improvement.

A system to implement the invention may comprise a computer or other processor-based system which may include processors, memory, storage devices, input-output devices, and other system components. The invention may also comprise a number of computer software components or modules that cause a processor to implement the functions and steps of the invention. For example, some embodiments of the invention may comprise data acquisition and trend analysis modules, location value score calculation modules, item fulfillment modules, accuracy analysis modules, and other modules. The location value score module may also comprise time series score and aggregation score modules. The item fulfillment module may also include time series score and aggregation score modules. The accuracy analysis module may also include one or more algorithms to enable stability of data analysis on scores. For example, one or more bootstrapping modules may be provided for stability analysis.

The invention also contemplates storage of one or more modules as machine readable code embodied in an electronic storage medium. For example, certain modules of the invention may be stored on optical discs (e.g., CD/ROM), floppy discs, or other electronic storage media.

The invention may also be exploited using a variety of business models. For example, a service or product provider may purchase or lease the appropriate software and hardware and implement the invention “in-house.” Alternatively, a data analysis provider may contract to perform appropriate analysis for any number of product or service providers. Other business models may also be used.

### BRIEF DESCRIPTION OF THE DRAWINGS

FIG. 1 is a block diagram depicted an analysis module according to one embodiment of the invention.

FIG. 2 is a schematic representation of a process for generating value at risk score according to one embodiment of the invention.

FIG. 3 pictorially represent the membership functions used in an embodiment of fuzzy value at risk scoring.

FIG. 4 illustrates a response surface of the fuzzy value at risk scoring according to one embodiment of the invention.

FIG. 5 illustrates a histogram of fulfillment value at risk scoring for a hypothetical portfolio of location-item pair according to one embodiment of the invention.

FIG. 6 is a schematic illustration of location value scoring 200 according to embodiment of the invention.

FIG. 7 is an example of fuzzy rules used in a fuzzy time series scoring module according to one embodiment of the invention.

FIG. 8 graphically depicts membership functions used in the fuzzy time series scoring according to one embodiment of the invention.

FIG. 9 illustrates examples of a response value surface according to one embodiment of the invention.

FIG. 10 depicts a hypothetical location portfolio for fuzzy time series scoring according to one embodiment of the invention.

FIG. 11 depicts a detailed calculation of the values depicted in FIG. 10.

FIGS. 12 and 13 depict fuzzy aggregation scoring for location value scores.

FIG. 14 depicts a hypothetical example of fuzzy aggregation scoring for location value scores.

FIG. 15 is a schematic illustration of item fulfillment scoring according to one embodiment of the invention.

FIG. 16 illustrates a hypothetical example of fuzzy time series scoring for item fulfillment scores.

FIG. 17 illustrates an example of item fulfillment scoring.

FIGS. 18 and 19 depict fuzzy aggregation scoring for item fulfillment scores.

FIG. 20 depicts a hypothetical example of fuzzy aggregation scoring.

### DETAILED DESCRIPTION OF EXEMPLARY EMBODIMENT(S)

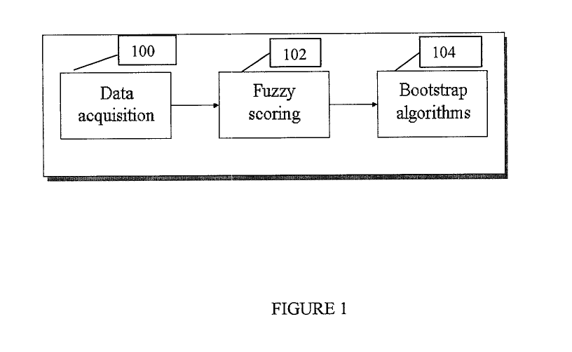

Another aspect of the invention is to provide a system and method for evaluation of various scores (calculated as described herein) or value at risk scores using fuzzy inference and statistical sampling techniques. This estimates the confidence intervals for the fulfillment score of each item, for the value score of each location and for the value at risk score of each item location pair. An embodiment of the analysis module may comprise a number of components, (e.g., show in FIG. 1) such as a data acquisition module 100 that captures key fulfillment performance indices, a fuzzy scoring module 102 that scores the an item or location score as described above and a bootstrap module 104 that estimates the confidence interval for the fulfillment score of each item. Here, we just use item fulfillment score as an example, the same applies to the other two scoring systems as well.

A method, according to an embodiment of the invention, obtains performance indices in an inventory, applies the fuzzy scoring model to the performance indices (as described herein) and assesses the stability of each score.

In an embodiment of the invention, one or more bootstrap algorithms are implemented by bootstrap module 104 in order to assess the accuracy of the fuzzy scores calculated as described herein. Bootstrap algorithms per se are known and may comprise computer-based methods that are suitable for answering statistical inference that is too complicated for traditional statistical analysis. Bootstrap algorithms may be based on the idea of sampling with replacement. In specific, bootstrap algorithms simulate the distribution of statistical estimates by repeatedly sampling with replacement in a known matter.

In some embodiments, bootstrap algorithms generally are composed of three main steps: sampling with replacement, evaluating statistics of interest and estimating confidence interval. For example, a bootstrap algorithm may process as follows:

For each item in the table

(Assume there are N records for this item)

Select n bootstrap samples using sampling with replacement

(assume n=100 and each bootstrap sample contains N records)

For each bootstrap sample

Compute its fulfillment score by the fuzzy scoring model

End of For

Sort the n fulfillment scores in ascending order.

Select the 6^{th} and the 96^{th} scores as the lower and the upper bounds of approximate 90% confidence interval, respectively

End of For

An example of applying the algorithm to a hypothetical inventory of PC peripherals is summarized in Table 1.

TABLE 1
Example of bootstrap estimates of item fulfillment scores.

| Item | | | | | | | 90% | # of |
|---|---|---|---|---|---|---|---|---|
| Id | Part # | Item Name | % OTS | MOTI | MDELAY | Score | Confidence | records |
| 1005 | C8050A | HP LASERJET | 0.93 | 0.41 short | 3.3 long | 0.80 | [0.66, 0.91] | 930 |
| | | 4100 N | excellent | | | | | |
| 1018 | P4152T | HP VECTRA | 0.86 | 0.71 short | 17.9 long | 0.66 | [0.24, 0.81] | 48 |
| | | VL400 DT | excellent | | | | | |
| | | P1GHZ | | | | | | |

The interpretation of Table 1 is summarized as follows. Over the last ten months, item 1005 has 930 records. Item 1005 is a HP LaserJet 4100N,™ which is the top item of total value. It has a fulfillment score of 0.8, which is the aggregate of 3 performance scores: 93% on-time shipments (e.g., %OTS), which scored a fuzzy excellent, 0.41 days of average order to invoice (MOTI), which earned a fuzzy short, and 3.3 days of average delay (MDELAY), which earned a fuzzy long.

The 90% confidence interval of the fulfillment score is [0.66, 0.91]. In other words, 90% of the time the score will not exceed 0.66 or 0.91. A similar analysis can be performed for item 1018 and other items.

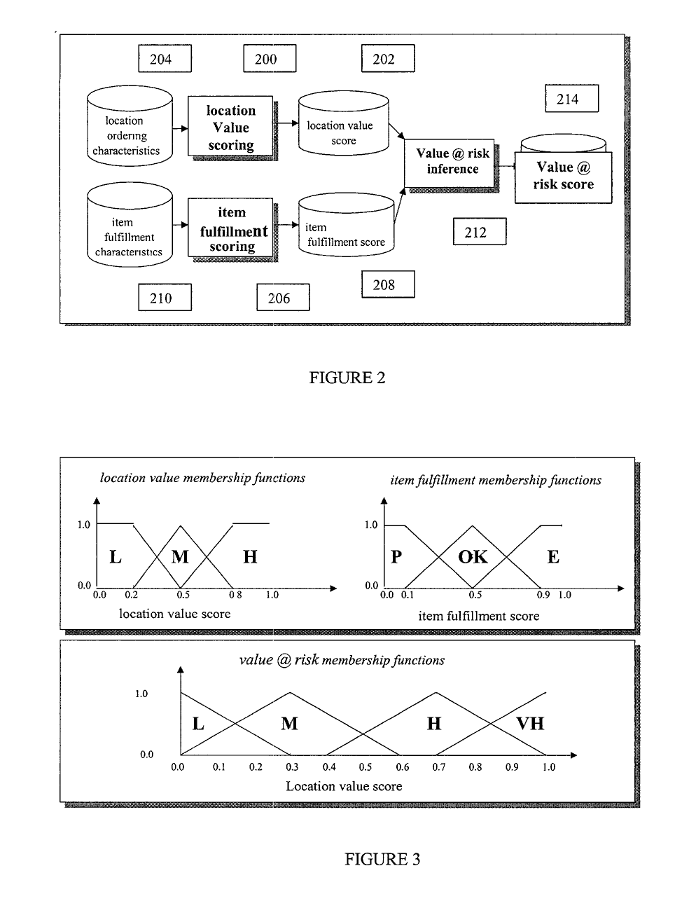

FIG. 2 is a schematic representation of a process for generating a value at risk score according to one embodiment of the invention. As shown, a location value scoring component 200 may enable calculation of a location value score 202 from a source of location ordering characteristic data 204. In addition, an item fulfillment scoring component 206 may enable calculation of an item fulfillment score 208 from a source of item fulfillment characteristic data 210. As indicated, location characteristic data 204, location value scores 202, item fulfillment characteristic data 210 and item fulfillment scores 208 may all be stored in an appropriate manner (e.g., in relational databases). A value at risk component 212 may enable calculation of a value at risk score 214 based, at least in part, upon the calculated location value score 202 and item fulfillment score 208.

Some embodiments of the invention may include a Data Acquisition component 100 that captures data (e.g., location ordering characteristics and item fulfillment characteristics) for use in calculating the various scores. This component may also comprise an independent, stand-alone component that can be performed as a separate service for product or service providers.

Data acquisition may be accomplished in any suitable manner. For example, data acquisition may be accomplished by capturing data from electronic data interchange (EDI) documents in a supply chain communications network, by periodically uploading data from relevant computers or other data sources, or other methods of data acquisition.

Data acquisition enables the determination of certain key performance indices (KPIs) for use in calculations. The KPIs may be selected from any suitable parameters that relate to an evaluation of value at risk scoring. For example, KPIs may include: a time stamp index (time.key), an item identification number (item.key), a location identification number (location.key), a relationship identification number (relationship.key), the total number of requests (total.requests), the total number of shipments (total.shipments), the total number of on time shipments (on.time.shipments), the total shipment delay (total.shipment.delay), the total requested quantity (total.requested.qty), the total shipped quantity (total.shipped.qty), the total value in currency (total.value), the total order to invoice time (total.oti), the number of completed requests (completed.requests), and other indices.

The acquired data may be stored in any suitable manner. For example, the data may be stored in a relational database where each record represents a transaction per request date, per item, per location. Other storage methods may also be used. The acquired data may undergo further processing as appropriate. For example, acquired data may be aggregated by item and by location for development of item fulfillment and location value scores as described below.

In an embodiment of the invention, value at risk scores are generated by applying inference rules to location value scores and item fulfillment scores. The value at risk scores provide a risk assessment for each (or selected) location-item pair. Location value and item fulfillment scores may be calculated in any suitable manner, including the manner described in more detail below.

Location value and item fulfillment scores may then be integrated using fuzzy inference logic. In brief, one aspect of the invention is that it identifies high value at risk transactions. The invention accomplishes this by assessing the risk fulfillment ranking by location-item pair using fuzzy logic techniques. Fuzzy logic techniques provides formal mathematical framework for assessing the uncertainty associated with human linguistic expression. For example, the invention may assess risk as follows: IF location value is high AND item fulfillment is poor, THEN value at risk is high, where high and poor are scores determined using fuzzy techniques.

An embodiment of the invention provides a fuzzy logic system including of a set of fuzzy logic rules that attempt to capture the input-output relationship between mean shifts and adjustments to mean, in terms of a set of heuristic rules using linguistic terms. This has the advantage of being a compact, easy-to-understand representation. One example of a set of rules is as follows.

TABLE 2

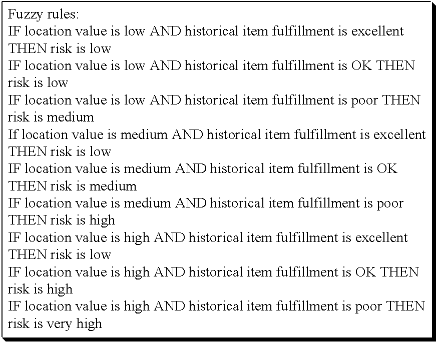

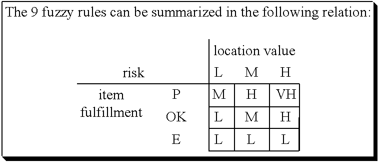

This is but one example of fuzzy rules that may be used in a fuzzy value at risk scoring component according to one embodiment of the invention. As shown in Table 2, fuzzy rules provide for various risk values based upon the various inputs for location value and item fulfillment.

In Table 2, P represents Poor; OK represents Okay; E represents Excellent; L represents Low; M represents Medium; H represents High; and VH represents Very High. Other parameters may be used. With item fulfillment on vertical axis 200 and location value on horizontal axis 202, the value at risk score may be read from the intersection of the respective axis values. For example, an item fulfillment value of Excellent (E) and a location value of Medium (M) give a value at risk value of Low (L).

The calculated value at risk scores may also be represented in membership functions. Membership functions derive from fuzzy set theory and provide, for a variable x over its universe of discourse X, the range of possible values of x. For a Boolean set B defined on X, for certain values of x, x is in the set; for all other values, it is not. In other words, B has a membership function μ_{B}(x) mapping x into {0,1}. Fuzzy logic extends this concept of set membership, allowing x to be a member of a fuzzy set A to a fractional degree. So, A would have a membership function μ_{A}(x) mapping x into [0,1]. The membership functions used in an embodiment of fuzzy value at risk scoring (e.g., as shown in Table 2) are pictorially represented in FIG. 3.

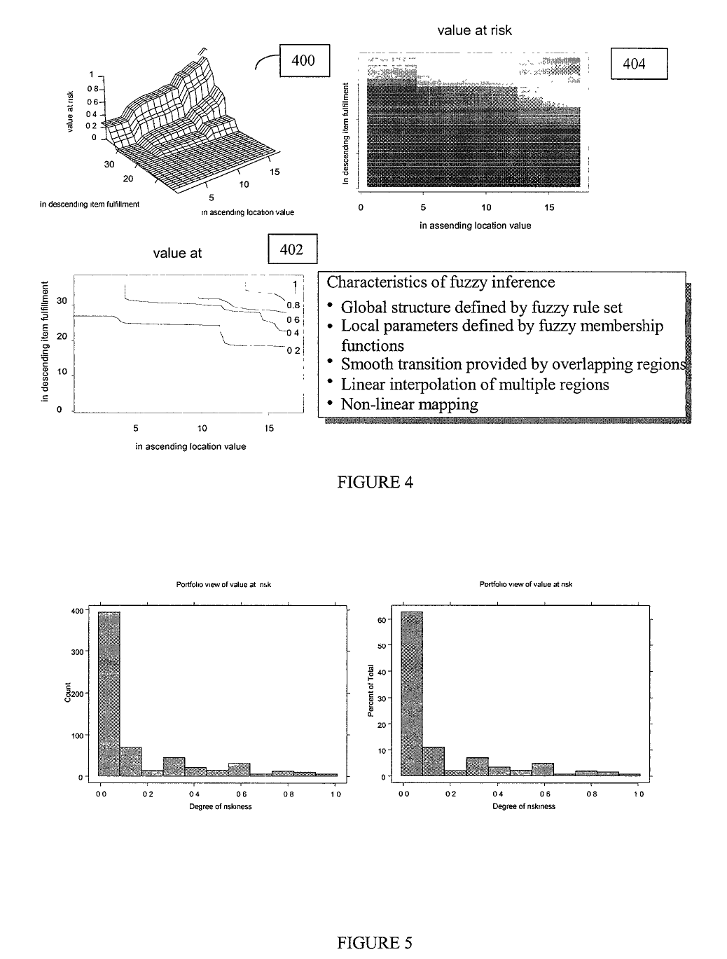

The invention also contemplates generating various visual representations of the response surface for value at risk scoring. For example, FIG. 4 illustrates a response surface of the fuzzy value at risk scoring according to an embodiment of the invention. The plot 400 shows a 3-D perspective plot of a response surface of value at risk. The plot 402 shows the same response surface in a contour plot, while the plot 404 shows the same response surface in an image plot. In the image plot 404, the white color represents values near zero, while positive and negative values are, respectively, located below to the left and above to the right of the near zero region.

FIG. 5 illustrates a histogram of fulfillment value at risk scores for a hypothetical portfolio of location-item pairs according to an embodiment of the invention. Histogram 500 represents a count versus degree of risk and histogram 502 represents a percent of total versus degree of risk. As shown, the volume of value at risk is less than 10 percent. Thus, for this portfolio, a management by exception approach may be implemented. Histogram 502 also illustrates that for more than 70% of location-item pairs in the portfolio, there is almost no risk at all.

In an embodiment of the invention, a series of histograms (e.g., such as those in FIG. 5) may be provided to enable evaluation of various business processes. Predetermined ones of these histograms may be monitored over time to evaluate continual risk management and business process evaluation. Of course, any combination of histograms may be monitored for any suitable time interval.

The following is a description of some other components of the invention according to various embodiments of the invention.

In some embodiments, location value component 202 may further comprise a number of sub-components. For example, location value component 202 may comprise a trending analysis module 600 that extracts short-term and long-term average value shifts, a fuzzy time-series scoring module 602 that derives individual scores for a set of value-related indices, a fuzzy aggregation scoring module 604 that infers the final value score from the set of individual scores. Other modules may also be included.

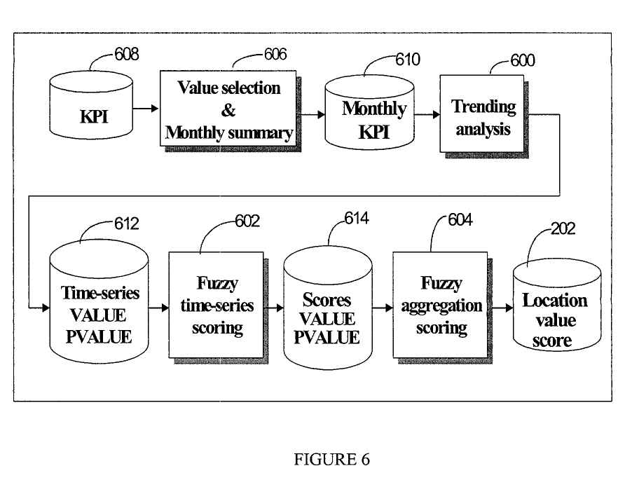

FIG. 6 is a schematic illustration of location value scoring 202 according to an embodiment of the invention. As indicated, a process for generating location value scores 202 for a portfolio may comprise obtaining a location's value-related indices in a portfolio (e.g., using value selection and summary module 606 to access performance index database 608), transforming the value-related indices into time-series data for a predetermined time interval (e.g., using value selection and summary module 606 to summarize the performance indices and store them in a summary database 610), extracting short-term and long-term value mean shifts from the time-series data (e.g., using trending analysis module 600 and storing the results in database 612), deriving individual value scores by applying the fuzzy time-series scoring module 602 to the value mean shifts (and storing them in database 614) and assessing the final score from the set of individual scores by fuzzy aggregation scoring module 604.

Databases 608, 610, 612 and 614 (as well as other databases described herein) may comprise a single database, a number of distributed databases, or some other configuration of data storage. In addition, each of the components (e.g., location value scoring 200, item fulfillment scoring 206, value at risk scoring 212, etc.) may comprise a separate data acquisition module (or modules), or a single data acquisition module may acquire data for each component, or some other configuration of data acquisition may be used.

In some embodiments, it may be desirable to compile data regarding high value locations and periodic time-series data. This data may be compiled in any suitable manner. For example, high value locations may be determined by selecting locations that comprise some predetermined percentage (e.g., up to 20% of total portfolio value). Other values may be chosen using factors such as coverage (e.g., trying to cover as many locations as possible) and reliability (trying to have enough location data to ensure that it is reliable).

Periodic time-series data may be compiled for any suitable time interval (e.g., monthly, weekly, daily, hourly, etc.) and for any desired statistic. In an embodiment of the invention, total monthly value (VALUE) and average value per quantity (PVALUE) may be compiled. Other summary statistics may also be used.

In an embodiment of the invention, trending analysis module 600 may provide a scoring mechanism to break ties where more than two time-series have the same statistical means. For example, some embodiments of trending analysis module 600 scoring mechanism rewards upward trends, but penalize downward trends.

An embodiment of implementing trending analysis module 600 to extract trending information may be summarized with reference to the following example. Suppose that only ten months of data exist, but the first and last month's data are incomplete. Hence, only eight data points per item (due to monthly aggregation) exist. A simple performance summary takes the mean over the eight data point time series. Trending analysis module 600 may further account for short and long-term trends (i.e., mean shifts). For example, long and short term mean shifts may be computed by taking a quarter-to-quarter (i.e., 3 month periods) percent change in mean (for long term shifts) and a month-to-month percent change in mean (for short term shifts). Of course other time periods may be used.

In an embodiment of the invention, fuzzy time-series scoring module 602 may take as input both the short-term and long-term mean shifts of value-related indices and give as output a value score for each value-related index. The basic idea is to tradeoff short-term and long-term trends by fuzzy inference and adjust the mean accordingly. Any suitable adjustment to the mean may be implemented. For example, if both long and short-term means drifts trends are upward, then the mean may be adjusted upwards. Other adjustments are possible.

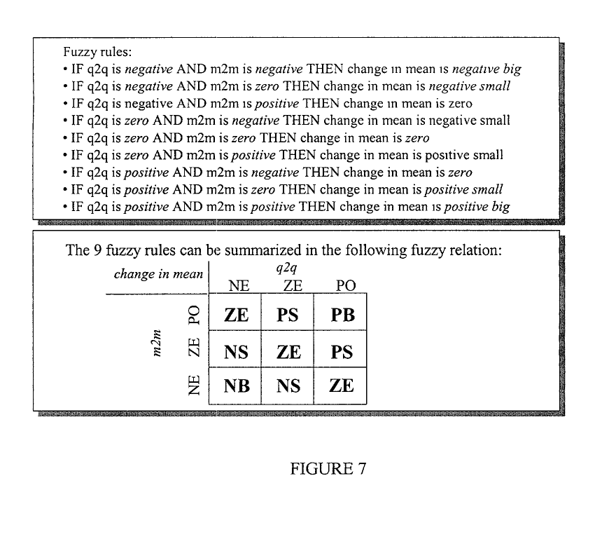

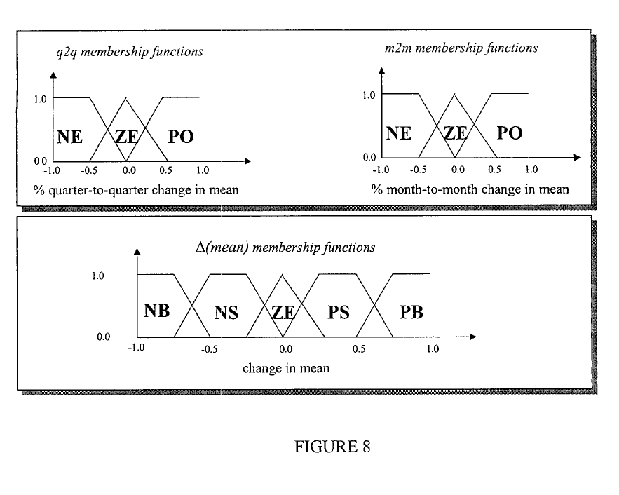

FIG. 7 is an illustration of example fuzzy rules used in a fuzzy time series scoring module according to one embodiment of the invention. The membership functions used in the fuzzy time-series scoring are graphically represented in FIG. 8. In the Figures, the abbreviations q2q stands for quarter-to-quarter, m2m stands for month-to-month, PO stands for positive, NE stands for negative, ZE stands for zero, B stands for big (e.g., PB=positive big) and S stands for small (e.g., NS=negative small).

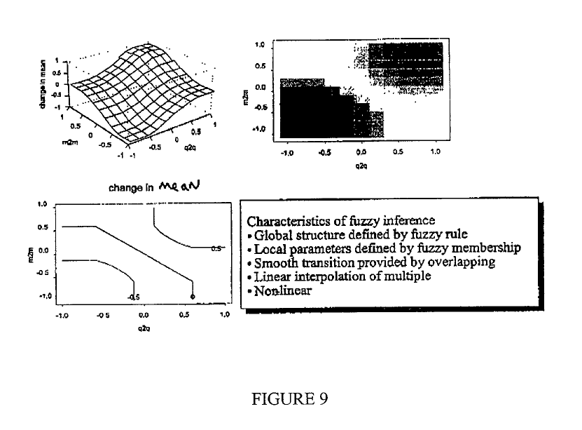

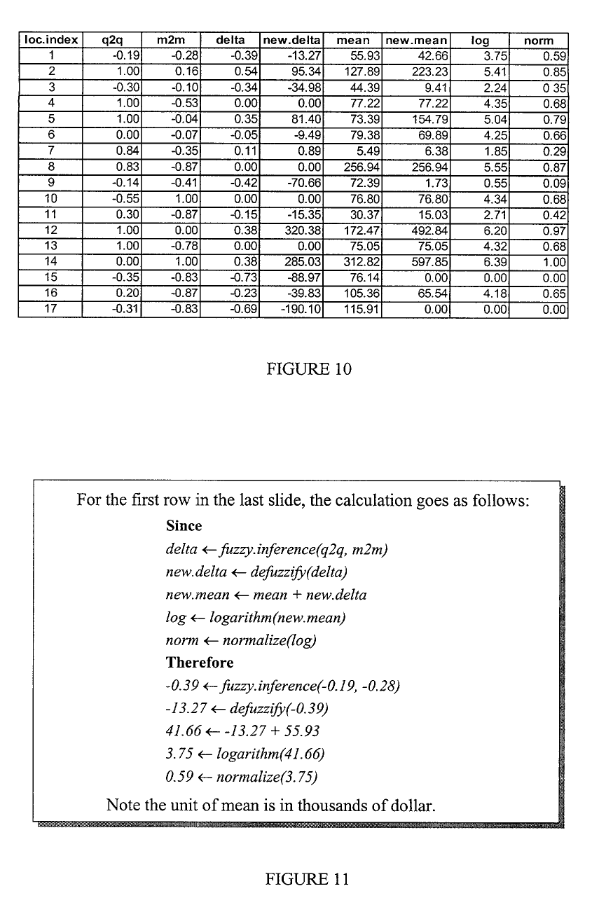

As with value at risk scoring, response surface representations may also be generated for location value time-series scoring. FIG. 9 illustrates examples of a response surface of fuzzy time-series scoring according to one embodiment of the invention. A hypothetical location portfolio for fuzzy time-series scoring is illustrated with reference to FIG. 10 and its detailed calculation is shown in FIG. 11.

In an embodiment of the invention, fuzzy aggregation scoring module 604 may take as input the two value-related scores and gives as output a final location value score 202. The basic idea is to tradeoff as well as integrate the two competing scores by fuzzy inference. For example, location value score may be very high if total value (e.g., VALUE) is high and average value per quantity (e.g., PVALUE) is high. Other scores are possible.

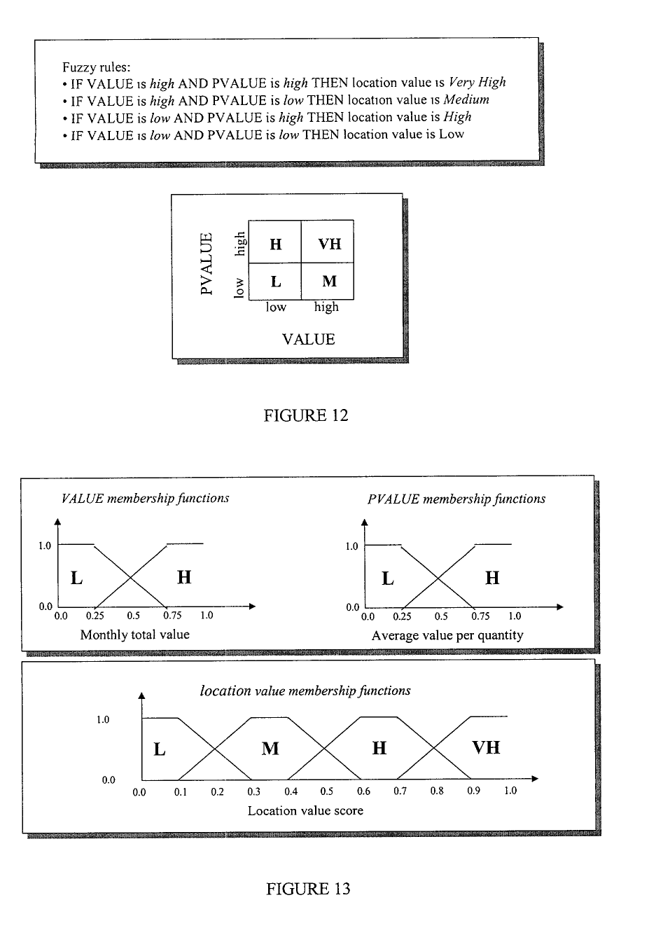

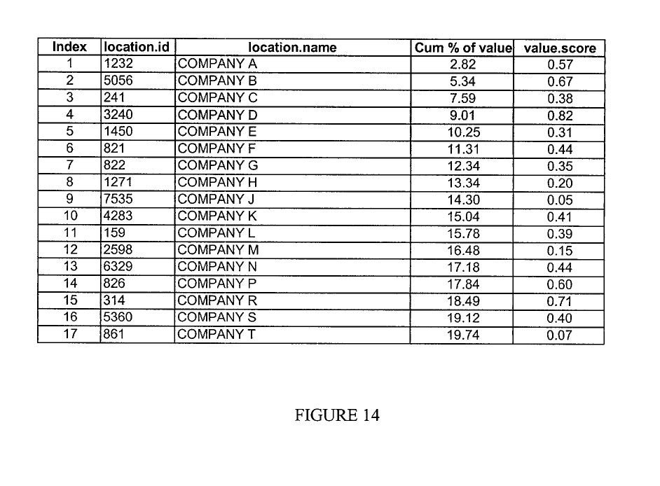

Similar to the illustrations for fuzzy time-series scoring, rules and membership functions for fuzzy aggregation scoring are schematically presented in FIGS. 12 and 13, respectively. A hypothetical example of fuzzy aggregation scoring is illustrated with reference to FIG. 14. As shown in FIG. 14, there are seventeen locations in the table, the value scores of the location id 3240 and 314 are 0.82 and 0.71, respectively.

In an embodiment of the invention, item fulfillment scoring module 206 may also comprise a number of modules. For example, item fulfillment scoring module 206 may comprise a trending analysis module 1500, a fuzzy time-series scoring module 1502 and a fuzzy aggregation scoring module 1504. These modules may comprise portions of the above mentioned location scoring modules (e.g., 600, 602, 604, etc.), independent modules, or some other configuration of modules.

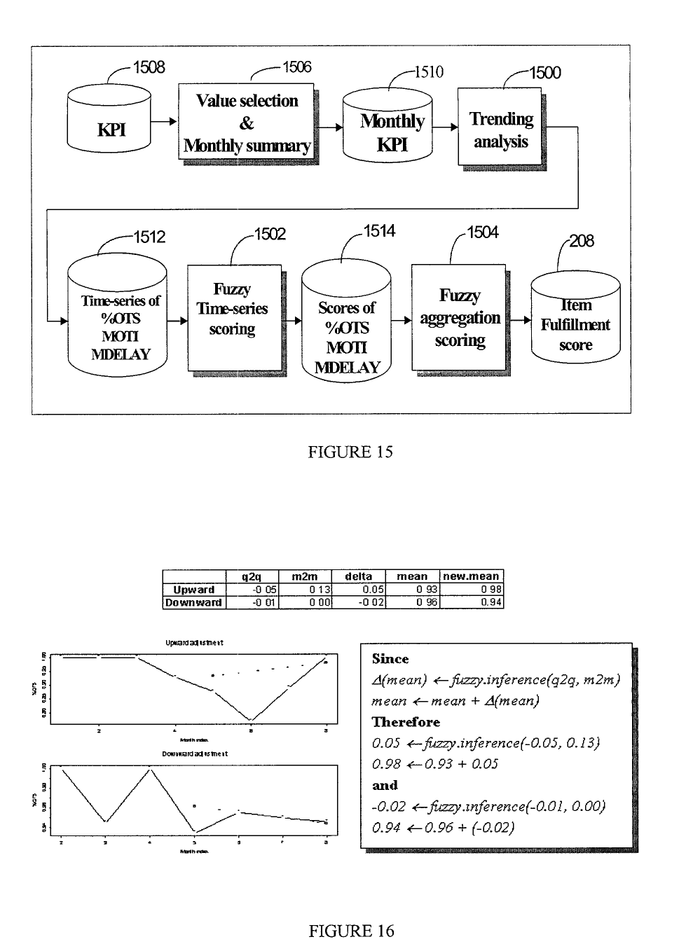

FIG. 15 is a schematic illustration of item fulfillment scoring 206 according to an embodiment of the invention. As indicated, a process for generating item fulfillment scores 208 for a portfolio may comprise obtaining an item's fulfillment-related indices in a portfolio (e.g., using value selection and summary module 1506 to access performance index database 1508), transforming the fulfillment-related indices into time-series data for a predetermined time interval (e.g., using value selection and summary module 1506 to summarize the performance indices and store them in a summary database 1510), extracting short-fulfillment and long-term fulfillment mean shifts from the time-series data (e.g., using trending analysis module 1500 and storing the results in database 1512), deriving individual fulfillment scores by applying the fuzzy time-series scoring module 1502 to the value mean shifts (and storing them in database 1514) and assessing the final score from the set of individual scores by fuzzy aggregation scoring module 1504.

Databases 1508, 1510, 1512 and 1514 (as well as other databases described herein) may comprise a single database, a number of distributed databases, or some other configuration of data storage.

In some embodiments, it may be desirable to compile data regarding high demand items and periodic time-series data. This data may be compiled in any suitable manner. For example, high demand items may be determined by selecting items that comprise up to 40% of total portfolio value. Other values may be chosen using factors such as coverage (e.g., trying to cover as many items as possible) and reliability (trying to have enough item data to ensure that it is reliable).

Periodic time-series data may be compiled for any suitable time interval (e.g., monthly, weekly, daily, hourly, etc.) and for any desired statistic. In an embodiment of the invention, percent of on time shipments (%OTS), average order to invoice (MOTI) and average shipment delay (MDELAY) may be compiled. Other summary statistics may also be used.

In an embodiment of the invention, trending analysis module 1500 may provide a scoring mechanism to break up ties where more than two time-series have the same statistical means. For example, some embodiments of trending analysis module 1500 scoring mechanism rewards up-ward trends, but penalize downward trends. This may be accomplished in a similar fashion as described above, or by using another trending scheme.

As described above with reference to FIG. 7, fuzzy time series scoring may be implemented using fuzzy rules (e.g., FIG. 7) for time series scoring of item fulfillment data. Likewise, membership functions and response surface plots may also be generated similar to those shown in FIGS. 8 and 9, respectively.

A hypothetical example of fuzzy time-series scoring is illustrated in FIG. 16. It shows two trending scenarios-one is up-ward and the other is downward. The first scenario can be interpreted as follows: If the long-term mean shift is −0.05 and the short-term mean shift is 0.13, then the mean adjustment is 0.05. Since the mean is 0.93, the new mean becomes 0.98. The downward scenario can be interpreted in a similar way.

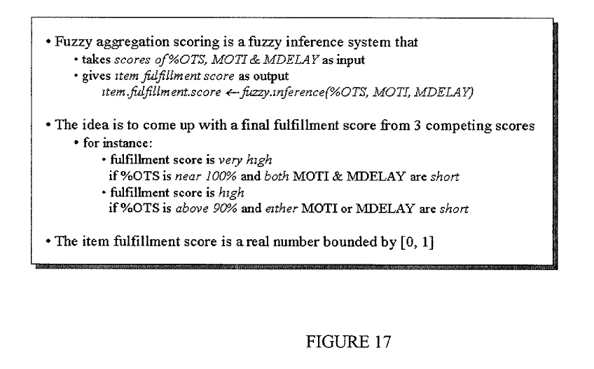

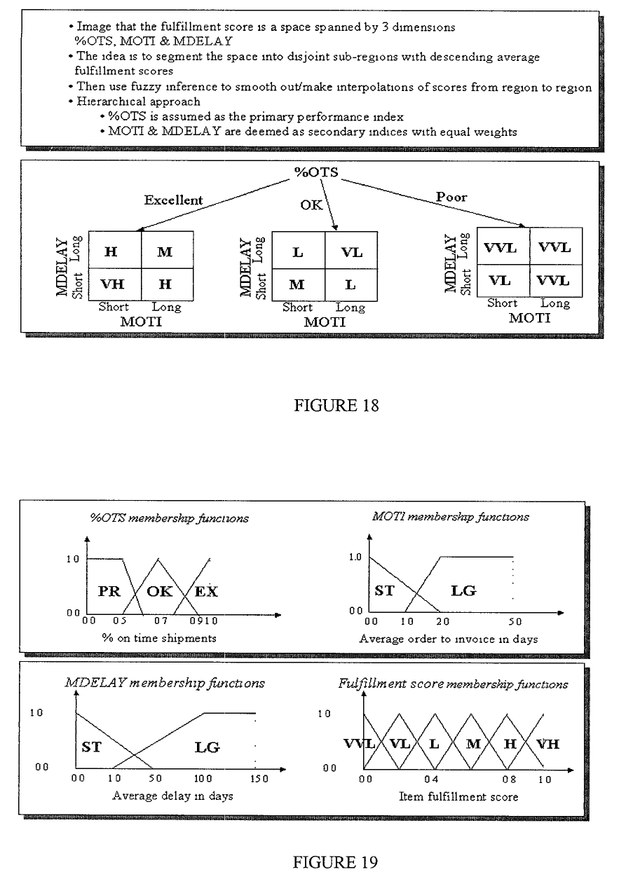

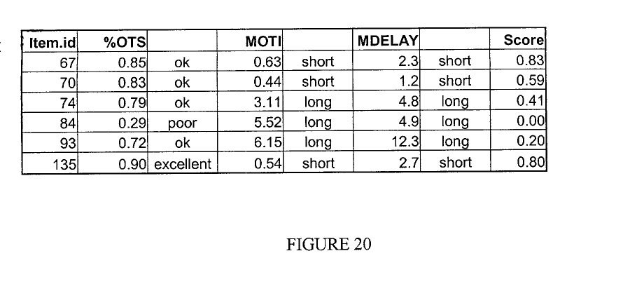

In an embodiment of the invention, fuzzy aggregation scoring module 1504 may take as input the three individual fulfillment scores (e.g., %OTS, MOTI and MDELAY) and give as output a final fulfillment score. The basic idea is to tradeoff as well as integrates the three competing scores by fuzzy inference as summarized in FIG. 17. Similar to the illustrations for fuzzy time-series scoring, rules and membership functions for fuzzy aggregation scoring are schematically presented in FIGS. 18 and 19, respectively. Finally, a hypothetical example of fuzzy aggregation scoring is illustrated in FIG. 20.

As shown in FIG. 20, there are ten items in the portfolio. For instance, the fulfillment score of the item in the first row is 0.83 since its % on time shipments is ok and its average order to invoice is short and its average delay is short. Similarly, the item in the last row has a fulfillment score of 0.80 since its % on time shipments is excellent and its average order to invoice is short and its average delay is short.

The present invention is not to be limited in scope by the specific embodiments described herein. Indeed, various modifications of the present invention, in addition to those described herein, will be apparent to those of ordinary skill in the art from the foregoing description and accompanying drawings. Thus, such modifications are intended to fall within the scope of the following appended claims. Further, although the present invention has been described herein in the context of a particular implementation in a particular environment for a particular purpose, those of ordinary skill in the art will recognize that its usefulness is not limited thereto and that the present invention can be beneficially implemented in any number of environments for any number of purposes. Each of the above components may be embodied in any number of suitable configurations. Likewise, the particular steps, or ordering of steps, to accomplish the method of the invention may be embodied in a number of configurations. Some particular configurations are described in more detail below. Accordingly, the claims set forth below should be construed in view of the full breath and spirit of the present invention as disclosed herein.

What is claimed:

1. A method for calculating a fulfillment value at risk score for a portfolio comprising a location and an item, the method comprising:
acquiring fulfillment performance data for the location and the item;
generating a location value score for the location;
generating a item fulfillment score for the item;
generating a value at risk score for the location and the item; and
assessing the stability of the fulfillment value at risk scores.

2. The method of claim 1 wherein the location value score is generated using a fuzzy logic technique.

3. The method of claim 1 wherein the item fulfillment score is generated using a fuzzy logic technique.

4. The method of claim 1 wherein the value at risk score is generated using a fuzzy logic technique.

5. The method of claim 1 wherein the acquiring fulfillment performance data for the location and item further comprises:
creating a list of performance indices from documents in a supply chain communications network;
storing the list of performance indices where each record represents a transaction per request date, per item, or per location; and
wherein the list of performance indices comprises one or more of total dollar value of requests, average dollar value per quantity, percent of on time shipments, average shipment delay, and average order to invoice time.

6. The method of claim 5 further comprising:
creating a summary of the performance indices.

7. The method of claim 6 further comprising:
summarizing data relating to the percentage of on time shipments, the average order to invoice time period and the average shipment delay period.

8. The method of claim 6 further comprising:
summarizing data relating to the total monthly value and average value per quantity for each location.

9. The method of claim 1 wherein generating a location value score for the location further comprises:
performing trending analysis to extract short-term and long-term average value shifts.

10. The method of claim 9 wherein the short-term average value shift is proportional to the percent change in mean for a predetermined first time period and the long-term average value shift is proportional to the percent change in mean for a predetermined second time period and wherein the first time period is shorter in duration that the second time period.

11. The method of claim 1 further comprising:
analyzing the generated item fulfillment score to evaluate an accuracy level.

12. The method of claim 2 wherein the fuzzy logic technique comprises:
applying one or more fuzzy logic rules.

13. The method of claim 12 wherein the one or more fuzzy logic rules comprise heuristic rules using linguistic terms.

14. The method of claim 3 wherein the fuzzy logic technique comprises:
applying one or more fuzzy logic rules.

15. The method of claim 14 wherein the one or more fuzzy logic rules comprise heuristic rules using linguistic terms.

16. The method of claim 4 wherein the fuzzy logic technique comprises:
applying one or more fuzzy logic rules.

17. The method of claim 16 wherein the one or more fuzzy logic rules comprise heuristic rules using linguistic terms.

18. The method of claim 1 further comprising:
generating a visual representation of the value at risk score.

19. The method of claim 1 further comprising the step of:
analyzing the generated location value score to evaluate an accuracy level.
